(19) United States
(12) Patent Application Publication
(10) Pub. No.: US 2021/0055081 A1
(43) Pub. Date: Feb. 25, 2021

(54) System for Dispensing Chemical Deterrents

(71) Applicant: Bruce Edward Blank, Middleton, RI (US)

(72) Inventor: Bruce Edward Blank, Middleton, RI (US)

(21) Appl. No.: 16/542,155

(22) Filed: Aug. 15, 2019

Related U.S. Application Data
(60) Provisional application No. 62/720,045, filed on Aug. 20, 2018.

(51) Int. Cl. F41H 9/00; B05B 9/03

(52) U.S. Cl. CPC F41H 9/00; B05B 9/035

(57) ABSTRACT

A system for dispensing chemical deterrents is used to disperse atomized liquid chemicals into an area in order to deter trespassers. The system is configured to respond to existing security systems. The system includes a plurality of dispensing units, a controller, and a wireless communication device. The plurality of dispensing units is a set of components that provide the storage and dispersal means for contained chemicals and deterrents. The controller is a unit which accepts electrical inputs and outputs appropriate electrical outputs throughout the plurality of dispensing units. The wireless communication device is a remote transceiver capable of receiving signals from security systems or mobile devices, such as personal computing (PC) devices, smartphones, laptops, and more. Further, the wireless communication device may also be capable of collecting and subsequently relaying data to appropriate devices. Together, these components allow the system to activate in response to an emergency.

The current application claims a priority to the U.S. Provisional Patent application Ser. No. 62/720,045 filed on Aug. 20, 2018.

### FIELD OF THE INVENTION

The present invention generally relates to a security system. More specifically, the present invention is a non-lethal deterrent system intended to disable an intruder by deploying a variety of environmental obstacles and direct irritants.

### BACKGROUND OF THE INVENTION

In present times, individuals are known to employ permanently installed security devices such as motion detectors, cameras, alarms, and emergency lighting systems that may be activated manually or automatically in response to intruders. These systems are generally built into a given installation during construction, often including local battery backups should site power fail or be otherwise interrupted. Other systems may be deployed as modular retrofits to existing structures, drawing power from integrated power supplies or generators and reporting the status of an area wirelessly to a remote terminal.

Unfortunately, while these systems can adequately alert the individuals in a local area to dangers via a series of alarms, and in some cases even summon the appropriate personnel to handle a hazardous scenario, systems known in the industry are generally incapable of responding to an intruder directly. Determined individuals may simply ignore an audible alarm or security lights, rendering the security system ineffective until such time as the appropriate authorities arrive. This response gap can be critical in scenarios involving an armed intruder in facilities not staffed with security personnel. Even the most sophisticated surveillance and sensor network becomes useless to actually prevent or deter an individual from advancing through a facility at will. What is needed is a device which physically deters intruders from occupying a protected space.

The present invention addresses this issue. The present invention aims to allow an authorized individual to deploy a measured, non-lethal response to an intruder. A variety of chemicals may be dispersed by the present invention to blind, disorient, or otherwise disable an intruder, while simultaneously preventing permanent damage to the facility, its inhabitants, or the intruder. These chemicals may serve a variety of additional functions including, but not limited to, alternative intruder deterrent, fire suppression, chemical neutralization, passive area denial, remote public address, emergency illumination, and various other functions known to be fulfilled by an installed security system. Additionally, the present invention may be retrofit to any existing installation via concealment within existing fixtures, such as fluorescent light enclosures or air conditioning vents. The present invention will further include provisions for remote operation and testing of all functional aspects, either via a closed-circuit network, wireless transmissions, or any combination thereof.

### BRIEF DESCRIPTION OF THE DRAWINGS

FIG. 1 is a perspective view of the present invention.

FIG. 2 is a side view of the present invention.

FIG. 3 is a schematic view of the first replaceable cannister of the present invention.

FIG. 4 is a schematic view of the second replaceable cannister of the present invention.

FIG. 5 is a schematic view of the third replaceable cannister of the present invention.

FIG. 6 is a process flow diagram representing the electrical connections of the present invention.

### DETAILED DESCRIPTION OF THE INVENTION

All illustrations of the drawings are for the purpose of describing selected versions of the present invention and are not intended to limit the scope of the present invention.

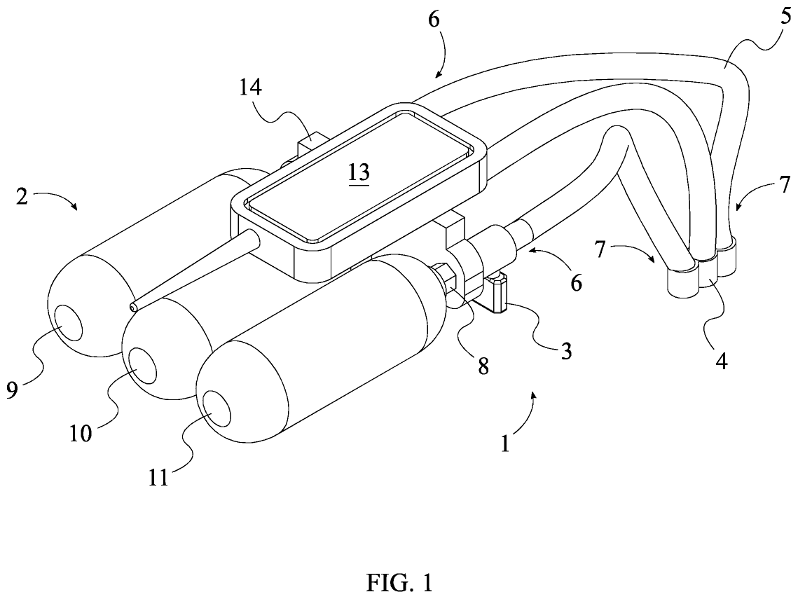

The present invention is a system for dispensing chemical deterrents that is used to disperse atomized liquid chemicals into an area in order to deter trespassers. The present invention is also configured to respond to existing security systems, so that when an existing security alarm is triggered, a corresponding activation signal is received by the present invention. The present invention comprises a plurality of dispensing units 1, a controller 12, and a wireless communication device 13. The plurality of dispensing units 1 is a set of components that provide the storage and dispersal means for contained chemicals and deterrents, as seen in FIG. 1. The controller 12 is a unit is an electrical unit capable of converting electrical inputs from sensors or alarm system signals and converting them into electrical instruction signals throughout the plurality of dispensing units 1. The controller 12 further includes all standard electrical components, such as wires, power supplies, resistors, capacitors, and other such components necessary for optimal operation of the present invention. The wireless communication device 13 is a remote transceiver capable of receiving signals from other security systems or mobile devices, such as personal computing (PC) devices, smartphones, laptops, and more. Further, the wireless communication device 13 may also be capable of collecting data including, but not limited to, the condition of the controller 12, the condition of the plurality of dispensing units 1, and the volume of various irritant fluids contained within the plurality of dispensing units 1, and subsequently relaying that data to appropriate devices such as remote servers or PC devices. Together, these components allow the present invention to activate in response to an emergency.

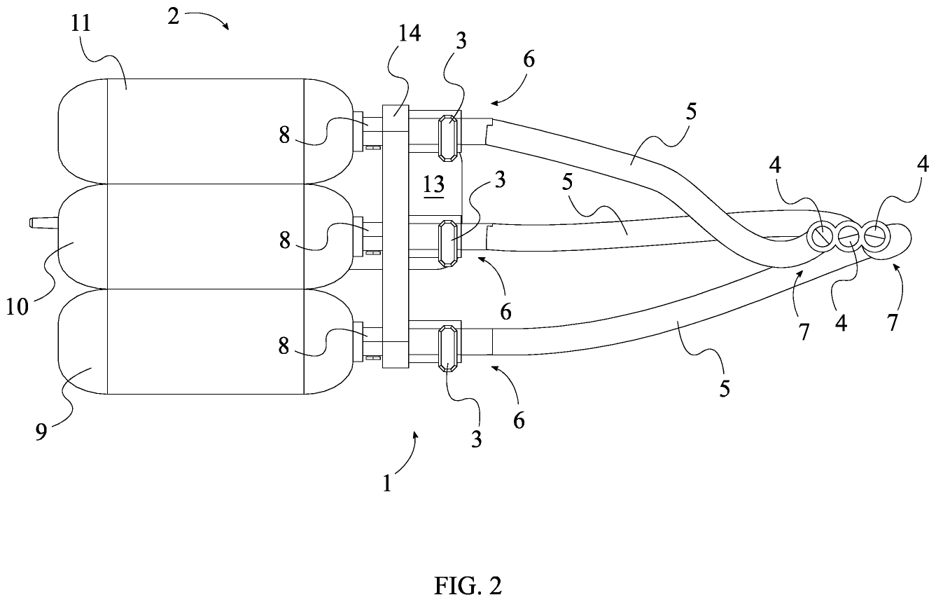

The general configuration of the aforementioned components allows the present invention to efficiently and effectively respond to emergency situations, as delineated by existing security systems or appropriately connected user PC devices. Each of the plurality of dispensing units 1 comprises a replaceable cannister 2, a valve 3, and an atomizer 4, as seen in FIG. 2. The replaceable cannister 2 is a preferably cylindrical high-pressure vessel capable of retaining various fluids in either liquid or gaseous form until time for dispersal. The valve 3 is an adjustable flow controller that opens to allow for the release of fluids from the replaceable cannister 2. The valve 3 may be any or none of a ball valve, a check valve, a pinch valve, a pressure relief valve, or a variety of other valve types not explicitly noted that are capable of releasing fluids into an atomizer 4 according to instruction from the controller 12. The atomizer 4 is a pressurized output that converts fluids from the replaceable cannister 2 into a spray and subsequently disperses that spray upon a target area. The replaceable cannister 2 is in fluid communication with the atomizer 4 through the valve 3. Thus, fluid that exits the replaceable cannister 2 through the valve 3 enters the atomizer 4. The replaceable cannister 2 and the atomizer 4 are positioned offset from each other. This arrangement prevents the flow of fluids directly from the replaceable cannister 2 to the atomizer 4 without the flow modulation provided by the valve 3. Furthermore, the wireless communication device 13 and each valve 3 of the plurality of dispensing units is electronically connected to the controller 12. In this arrangement, the controller 12 is capable of communicating electrical signals for the valve 3 in accordance to the input sent from the wireless communication device 13.

The atomizer 4 may benefit from being aimable, as such functionality allows for more versatile mounting of the present invention. To accommodate this desire, each of the plurality of dispensing units 1 further comprises a malleable tube 5, as seen in FIG. 2. The malleable tube 5 is a flexible, shape-retaining hollow cylinder that allows for adjustable positioning of connected components relative to each other while simultaneously providing a conduit for fluid transfer. The malleable tube 5 comprises a first tube end 6 and a second tube end 7. The first tube end 6 is an opening opposite the second tube end 7 through which fluid may flow. Similarly, the second tube end 7 is an opening opposite the first tube end 6 that allows for fluid flow. The valve 3 is hermetically connected to the first tube end 6. Thus, fluid exiting the replaceable cannister 2 through the valve 3 can enter the malleable tube 5 in a lossless transition. Simultaneously, the atomizer 4 is hermetically connected to the second tube end 7. Therefore, fluid entering the first tube end 6 is discharged directly to the atomizer 4 for dispersal.

The present invention is optimally connected to existing structural or functional features of a building or location. To this end, the present invention further comprises a fixture attachment mechanism 14, as seen in FIGS. 1 and 2. The fixture attachment mechanism 14 is a fastener or connector that allows for mounting of the present invention in an appropriate position for use. The fixture attachment mechanism 14 may include any or a combination of screws, bolts, adhesives, fixtures, tapes, fasteners, or a variety of other connection mechanisms not outlined above capable of securing the present invention appropriately for all functions. The plurality of dispensing units 1 is mounted onto the fixture attachment mechanism 14. Thus, the fixture attachment mechanism 14 provides leverage to support the present invention in optimal position as desired during installation.

The replaceable cannister 2 contains a fixed quantity of fluid and may therefore eventually become low or empty after repeated use. To accommodate for such an occasion, each of the plurality of dispensing units 1 further comprises a releasable fastener 8, as seen in FIG. 2. The releasable fastener 8 relates to a mechanism capable of retaining the replaceable cannister 2 in place during use. Simultaneously, the releasable fastener 8 allows for removal of the replaceable cannister 2 for replacement of maintenance purposes. The releasable fastener 8 may include adhesives, threading, latches, locks, grips, friction fits, ferrules, or a variety of other secure retaining mechanisms that allow for containment and release of the replaceable cannister 2. The replaceable cannister 2 is hermetically connected to the valve 3 by the releasable fastener 8. Thus, there is no potentially harmful loss of either the contained fluid or the pressure within the replaceable cannister 2 during the transition from the replaceable cannister 2 to the valve 3.

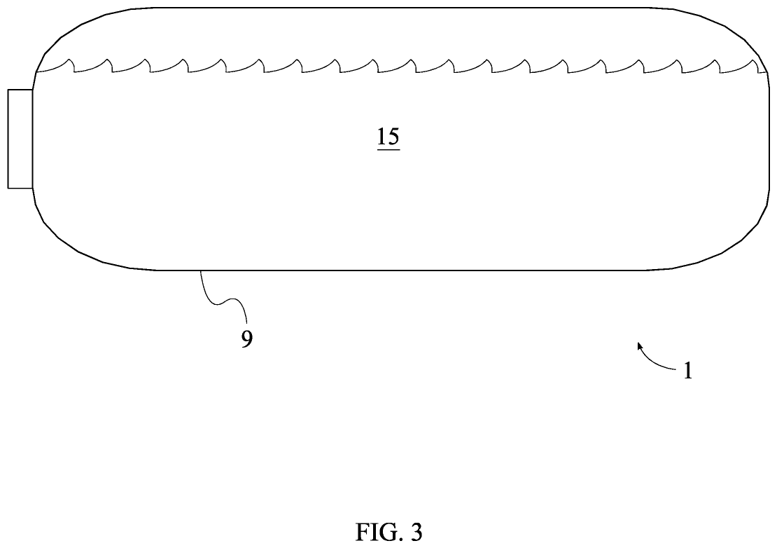

One technique for disturbing or incapacitating a trespasser or building assailant is to distract the assailant with itching, burning, sores, or other such chemicals. To achieve such an end, the present invention further comprises a quantity of liquid irritant 15, as represented in FIG. 3. The quantity of liquid irritant 15 may be any or a combination of mace, pepper spray, tear gas, or a variety of other nerve agents, blistering agents, choking agents or incapacitating agents capable of disturbing the assailant's ability to function properly. The plurality of dispensing units 1 comprises a first replaceable cannister 9. The first replaceable cannister 9 is a high-pressure hollow cylindrical vessel that provides storage for the quantity of liquid irritant 15. The quantity of liquid irritant 15 is retained within the first replaceable cannister 9. Thus, the first replaceable cannister 9 is supplied with a volume of fluid capable of incapacitating or disturbing an assailant.

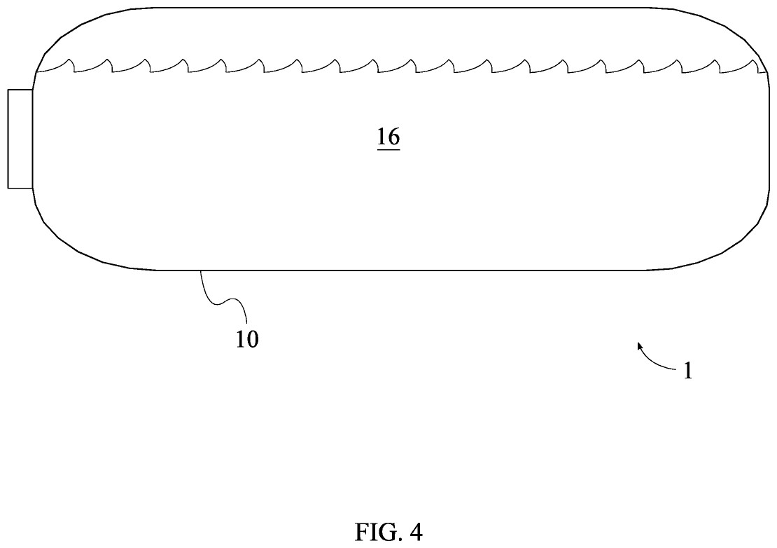

Another approach for affecting an assailant's ability to perform potentially hostile or unauthorized actions on controlled property is to target the assailant's ambulatory or dexterous function. To this end, the present invention further comprises a quantity of liquid lubricant 16, as represented in FIG. 4. The quantity of liquid lubricant 16 is a volume of oil, surfactant, soap, or other such friction-reducing agents capable of preventing natural movement of an assailant upon a coated floor or surface, or in using machinery or weaponry. The plurality of dispensing units 1 comprises a second replaceable cannister 10. The second replaceable cannister 10 is a high-pressure hollow cylindrical vessel that provides storage for the quantity of liquid lubricant 16. The quantity of liquid lubricant 16 is retained within the second replaceable cannister 10. Thus, the second replaceable cannister 10 is supplied with a volume of fluid capable of disarming or stopping the forward progress of an assailant.

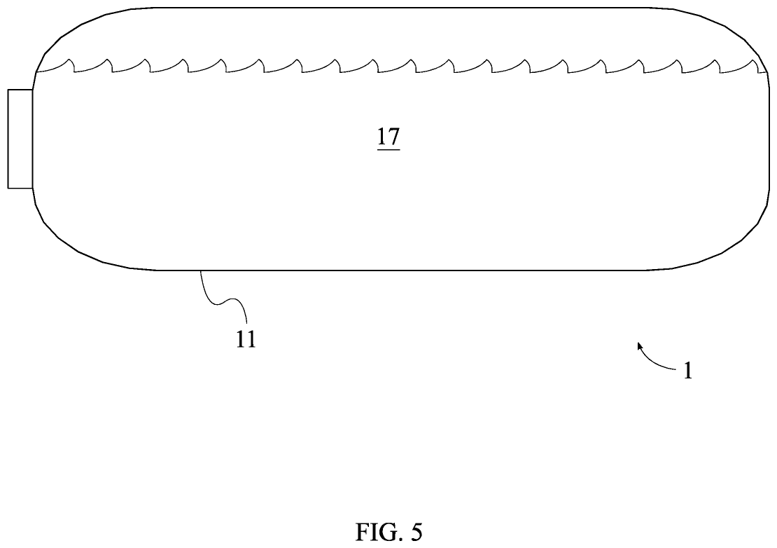

Yet another potential approach to reducing the effectiveness of an assailant is to target the assailant's visual function. In order to provide this functionality, the present invention further comprises a quantity of liquid obscurant 17, as represented in FIG. 5. The quantity of liquid obscurant 17 is a volume of liquid or gas, such as various smokes, mists, fogs, or other such fluids capable of affecting the vision, depth perception, focus, resolution, or other visual capabilities of an assailant. The plurality of dispensing units 1 comprises a third replaceable cannister 11. The third replaceable cannister 11 is a high-pressure hollow cylindrical vessel that provides storage for the quantity of liquid obscurant 17. The quantity of liquid obscurant 17 is retained within the third replaceable cannister 11. Thus, the third replaceable cannister 11 is supplied with a volume of fluid capable of impeding an assailant's vision.

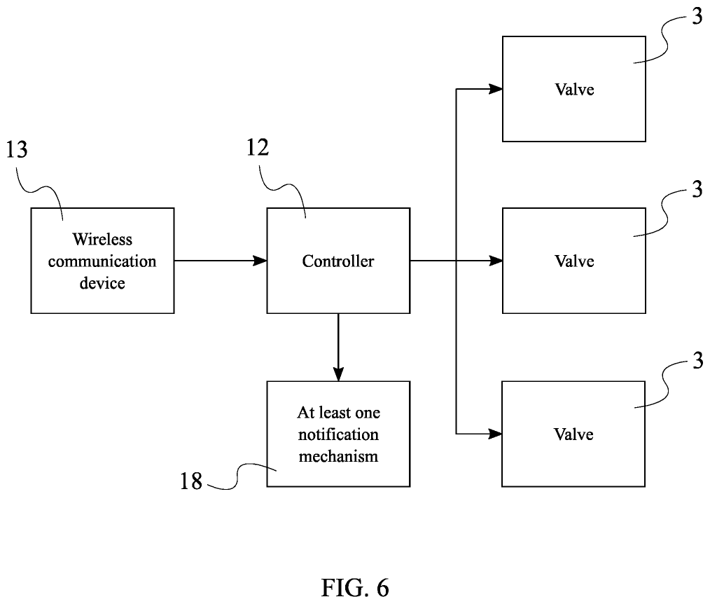

With the various hazards presented by the dispersal of the contained fluids, the present invention may be further advantageous and helpful with a mechanism for alerting non-hostile or permitted entities to incoming fluid dispersal. To accommodate this need, the present invention further comprises at least one notification mechanism 18, as represented in FIG. 6. The at least one notification mechanism 18 relates to any of a variety of alerts able to notify nearby parties of incoming fluid dispersal. The at least one notification mechanism 18 may include any or a combination of security lights, speakers, lasers, or other preferably visual or auditory stimuli capable of adequately alerting nearby parties. The at least one notification mechanism 18 is electronically connected to the controller 12. Thus, the at least one notification mechanism 18 can be activated in response to security systems or connected user PC devices.

In an exemplary usage of the present invention, a user connects at least one replaceable cannister 2 to the plurality of valves 3 with the corresponding releasable fastener 8. The replaceable cannister 2 may be full of the quantity of liquid irritant 15, the quantity of liquid lubricant 16, the quantity of liquid obscurant 17, or a variety of other materials and fluids. The user may then connect the plurality of dispensing units 1 to an existing lighting fixture, wall, or other feature of the building with the fixture attachment mechanism 14. Following that, the user adjusts the malleable tube 5. By modifying the arrangement of the malleable tube 5, the user can control the direction which the atomizer 4 sprays the volume of fluid. The user then connects the controller 12 to an external security system, so that when the external security system is triggered, the controller 12 can send appropriate signals to the plurality of dispensing units 1 and the at least one notification mechanism 18. Thus, the present invention is prepared to disperse fluid from the replaceable cannister 2. Upon completion of fluid dispersal, the valve 3 closes. In an alternative embodiment, the present invention relays an update to the user PC device with information about remaining fluid quantities. The present invention will ideally be able to connect to existing power infrastructure generally understood to be accessible in proximity to existing fixtures, negating the need to run new cabling or regularly replace integrated batteries. Further, the present invention may utilize disposable or reusable batteries to provide components with adequate electrical power.

Although the invention has been explained in relation to its preferred embodiment, it is to be understood that many other possible modifications and variations can be made without departing from the spirit and scope of the invention as hereinafter claimed.

What is claimed is:

1. A system for dispensing chemical deterrents comprises:
a plurality of dispensing units;
a controller;
a wireless communication device;
each of the plurality of dispensing units comprises a replaceable cannister, a valve, and an atomizer;
the replaceable cannister being in fluid communication with the atomizer through the valve;
the replaceable cannister and the atomizer being positioned offset from each other; and
the wireless communication device and each of the plurality of dispensing units being electronically connected to the controller.

2. The system for dispensing chemical deterrents as claimed in claim 1 comprises:
each of the plurality of dispensing units further comprises a malleable tube;
the malleable tube comprises a first tube end and a second tube end;
the valve being hermetically connected to the first tube end; and
the atomizer being hermetically connected to the second tube end.

3. The system for dispensing chemical deterrents as claimed in claim 1 comprises:
a fixture attachment mechanism; and
the plurality of dispensing units being mounted onto the fixture attachment mechanism.

4. The system for dispensing chemical deterrents as claimed in claim 1 comprises:
each of the plurality of dispensing units further comprises a releasable fastener; and
the replaceable cannister being hermetically connected to the valve by the releasable fastener.

5. The system for dispensing chemical deterrents as claimed in claim 1 comprises:
a quantity of liquid irritant;
the plurality of dispensing units comprises a first replaceable cannister; and
the quantity of liquid irritant being retained within the first replaceable cannister.

6. The system for dispensing chemical deterrents as claimed in claim 1 comprises:
a quantity of liquid lubricant;
the plurality of dispensing units comprises a second replaceable cannister; and
the quantity of liquid lubricant being retained within the second replaceable cannister.

7. The system for dispensing chemical deterrents as claimed in claim 1 comprises:
a quantity of liquid obscurant;
the plurality of dispensing units comprises a third replaceable cannister; and
the quantity of liquid obscurant being retained within the third replaceable cannister.

8. The system for dispensing chemical deterrents as claimed in claim 1 comprises:
at least one notification mechanism; and
the at least one notification mechanism being electronically connected to the controller.

9. A system for dispensing chemical deterrents comprises:
a plurality of dispensing units;
a controller;
a wireless communication device;
a fixture attachment mechanism;
each of the plurality of dispensing units comprises a replaceable cannister, a valve, and an atomizer;
the replaceable cannister being in fluid communication with the atomizer through the valve;
the replaceable cannister and the atomizer being positioned offset from each other;
the wireless communication device and each of the plurality of valves being electronically connected to the controller; and
the plurality of dispensing units being mounted onto the fixture attachment mechanism.

10. The system for dispensing chemical deterrents as claimed in claim 9 comprises:
each of the plurality of dispensing units further comprises a malleable tube;
the malleable tube comprises a first tube end and a second tube end;
the valve being hermetically connected to the first tube end; and
the atomizer being hermetically connected to the second tube end.

11. The system for dispensing chemical deterrents as claimed in claim 9 comprises:
each of the plurality of dispensing units further comprises a releasable fastener; and
the replaceable cannister being hermetically connected to the valve by the releasable fastener.

12. The system for dispensing chemical deterrents as claimed in claim 9 comprises:
a quantity of liquid irritant;
the plurality of dispensing units comprises a first replaceable cannister; and
the quantity of liquid irritant being retained within the first replaceable cannister.

13. The system for dispensing chemical deterrents as claimed in claim 9 comprises:
a quantity of liquid lubricant;
the plurality of dispensing units comprises a second replaceable cannister; and
the quantity of liquid lubricant being retained within the second replaceable cannister.

14. The system for dispensing chemical deterrents as claimed in claim 9 comprises:
a quantity of liquid obscurant;
the plurality of dispensing units comprises a third replaceable cannister; and
the quantity of liquid obscurant being retained within the third replaceable cannister.

15. The system for dispensing chemical deterrents as claimed in claim 9 comprises:
at least one notification mechanism; and
the at least one notification mechanism being electronically connected to the controller.

16. A system for dispensing chemical deterrents comprises:
a plurality of dispensing units;
a controller;
a wireless communication device;
a fixture attachment mechanism;
each of the plurality of dispensing units comprises a replaceable cannister, a valve, an atomizer, a malleable tube, and a releasable fastener;
the malleable tube comprises a first tube end and a second tube end;
the replaceable cannister being in fluid communication with the atomizer through the valve;
the replaceable cannister and the atomizer being positioned offset from each other;
the wireless communication device and each of the plurality of valves being electronically connected to the controller;
the plurality of dispensing units being mounted onto the fixture attachment mechanism;
the valve being hermetically connected to the first tube end;
the atomizer being hermetically connected to the second tube end; and
the replaceable cannister being hermetically connected to the valve by the releasable fastener.

17. The system for dispensing chemical deterrents as claimed in claim 16 comprises:
a quantity of liquid irritant;
the plurality of dispensing units comprises a first replaceable cannister; and
the quantity of liquid irritant being retained within the first replaceable cannister.

18. The system for dispensing chemical deterrents as claimed in claim 16 comprises:
a quantity of liquid lubricant;
the plurality of dispensing units comprises a second replaceable cannister; and
the quantity of liquid lubricant being retained within the second replaceable cannister.

19. The system for dispensing chemical deterrents as claimed in claim 16 comprises:
a quantity of liquid obscurant;
the plurality of dispensing units comprises a third replaceable cannister; and
the quantity of liquid obscurant being retained within the third replaceable cannister.

20. The system for dispensing chemical deterrents as claimed in claim 16 comprises:
at least one notification mechanism; and
the at least one notification mechanism being electronically connected to the controller.
